(19) United States
(12) Patent Application Publication
(10) Pub. No.: US 2022/0193830 A1
(43) Pub. Date: Jun. 23, 2022

(54) LASER PROCESSING APPARATUS

(71) Applicant: DISCO CORPORATION, Tokyo (JP)

(72) Inventor: Kenji FURUTA, Tokyo (JP)

(21) Appl. No.: 17/457,276

(22) Filed: Dec. 2, 2021

(30) Foreign Application Priority Data
Dec. 18, 2020 (JP) 2020-210692

(51) Int. Cl. B23K 26/53; B23K 26/04; B23K 26/03; B23K 26/064; B23K 26/06

(52) U.S. Cl. CPC B23K 26/53; B23K 26/048; B23K 26/0665; B23K 26/064; B23K 26/032

(57) ABSTRACT

A laser processing apparatus includes a condensing lens configured to form a condensing point of an applied laser beam and form a focus of a camera; a focus adjusting unit configured to adjust a height of the focus of the camera by moving a base to which the camera and the condensing lens are fixed in a height direction perpendicular to a holding surface of a chuck table; a condensing point adjusting unit disposed between a laser oscillator and the condensing lens, and configured to shift a height of the condensing point of the laser beam without changing a height of the condensing lens; and a control unit including a registering section configured to register the heights of the condensing point and the focus, the control unit being configured to control the focus adjusting unit and the condensing point adjusting unit on the basis of information of the registering section.

### BACKGROUND OF THE INVENTION

### Field of the Invention

The present invention relates to a laser processing apparatus.

### Description of the Related Art

When various kinds of device chips such as an integrated circuit (IC), a large scale integration (LSI) circuit, a light emitting diode (LED), and a power device are manufactured, devices are formed on a semiconductor wafer as a workpiece, and the semiconductor wafer is divided into individual chips. In the past, dicing by a cutting blade has been used for the division into the individual chips. However, a street (planned dividing line) width equal to or more than the thickness of the blade is necessary, and a large amount of cutting waste occurs and may adhere to the devices. Accordingly, as a dividing method that can reduce the street width and suppress the occurrence of the cutting waste, a dividing method is known which forms a modified layer as a fracture starting point by condensing a laser beam of a wavelength transmissible through the workpiece within the workpiece (see Japanese Patent Laid-Open No. 2017-084923, for example).

### SUMMARY OF THE INVENTION

However, there has been a desire to, in fracturing the wafer by cracks occurring from modified layers, check whether the cracks have occurred without a break in all of lines. Accordingly, it is possible to photograph the lines after processing by a camera and to detect the cracks. However, an inspection time is increased, so that production efficiency is decreased.

It is accordingly an object of the present invention to provide a laser processing apparatus that can efficiently check whether a crack has occurred from a modified layer.

In accordance with an aspect of the present invention, there is provided a laser processing apparatus for irradiating a workpiece with a laser beam along a planned dividing line set on the workpiece, the laser processing apparatus including a chuck table configured to hold the workpiece by a holding surface; a laser oscillator configured to emit the laser beam of a wavelength transmissible through the workpiece; a camera configured to image the workpiece; a light source configured to illuminate an imaging region for the camera; a condensing lens configured to form a condensing point of the applied laser beam and form a focus of the camera; a focus adjusting unit configured to adjust a height of the focus of the camera by moving a base to which the camera and the condensing lens are fixed in a height direction perpendicular to the holding surface; a condensing point adjusting unit disposed between the laser oscillator and the condensing lens, and configured to shift a height of the condensing point of the laser beam without changing a height of the condensing lens; and a control unit including a registering section configured to register the heights of the condensing point and the focus, the control unit being configured to control the focus adjusting unit and the condensing point adjusting unit on the basis of information of the registering section. While the condensing point is set within the workpiece, and a modified layer is formed within the workpiece along the planned dividing line, a crack extending from the modified layer to an exposed surface of the workpiece is photographed by the camera having the focus set at the exposed surface.

Preferably, the condensing point adjusting unit is a spatial light phase modulator or a beam expander.

The above and other objects, features and advantages of the present invention and the manner of realizing them will become more apparent, and the invention itself will best be understood from a study of the following description and appended claims with reference to the attached drawings showing a preferred embodiment of the invention.

### BRIEF DESCRIPTION OF THE DRAWINGS

FIG. 1 is a block diagram illustrating an example of a configuration of a laser processing apparatus according to an embodiment;

FIG. 2 is a perspective view illustrating an example of a workpiece as a processing target of the laser processing apparatus in FIG. 1;

FIG. 3 is a diagram illustrating an example of registration data registered by a registering section of the laser processing apparatus in FIG. 1;

FIG. 4 is a sectional view illustrating an example of operation of the laser processing apparatus in FIG. 1; and

FIG. 5 is a sectional view illustrating another example of the operation of the laser processing apparatus in FIG. 1.

### DETAILED DESCRIPTION OF THE PREFERRED EMBODIMENT

An embodiment of the present invention will hereinafter be described in detail with reference to the drawings. The present invention is not limited by contents described in the following embodiment. In addition, constituents described in the following include constituents readily conceivable by those skilled in the art and essentially identical constituents. Further, configurations described in the following can be combined with each other as appropriate. In addition, various omissions, replacements, or modifications of configurations can be performed without departing from the spirit of the present invention.

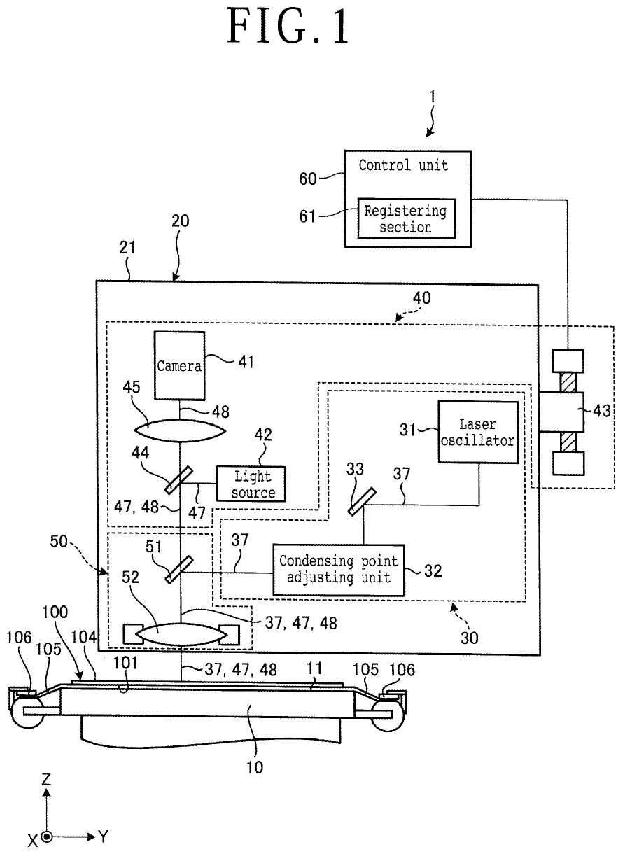

A laser processing apparatus 1 according to an embodiment of the present invention will be described with reference to the drawings. FIG. 1 is a diagram illustrating an example of a configuration of the laser processing apparatus 1 according to the embodiment. As illustrated in FIG. 1, the laser processing apparatus 1 according to the embodiment includes a chuck table 10, a laser processing unit 20, and a control unit 60.

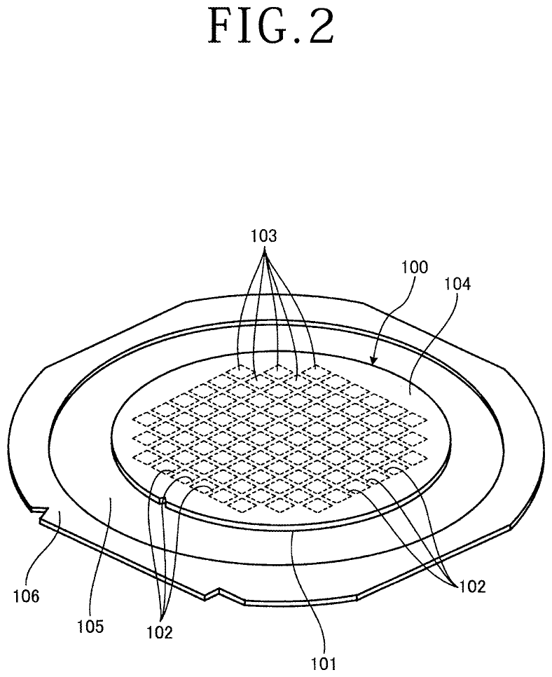

FIG. 2 is a perspective view illustrating an example of a workpiece 100 as a processing target of the laser processing apparatus 1 in FIG. 1. In the present embodiment, as illustrated in FIG. 2, the workpiece 100 as a processing target to be processed by the laser processing apparatus 1 is, for example, a semiconductor wafer, an optical device wafer, or the like in a disk shape which wafer includes silicon, sapphire, silicon carbide (SiC), gallium arsenide, or the like as a base material. The workpiece 100 has chip-size devices 103 formed in regions demarcated by a plurality of planned dividing lines (streets) 102 formed in a lattice manner on a flat top surface 101. The workpiece 100 in the present embodiment has an adhesive tape 105 affixed to the top surface 101, and an annular frame 106 is fitted to an outer edge portion of the adhesive tape 105. However, the present invention is not limited to this. In addition, the workpiece 100 in the present invention may be a rectangular package substrate having a plurality of devices sealed by a resin, a ceramic plate, a glass plate, or the like.

The chuck table 10 includes a disk-shaped frame body having a recessed portion formed therein and a disk-shaped suction portion fitted into the recessed portion. The suction portion of the chuck table 10 is formed of a porous ceramic having a large number of porous holes or the like, and is connected to a vacuum suction source not illustrated via a vacuum suction path not illustrated. The upper surface of the suction portion of the chuck table 10 is a holding surface 11 that is mounted with the workpiece 100 and holds the mounted workpiece 100 under suction. In the present embodiment, the holding surface 11 is mounted with the workpiece 100 in a state in which an undersurface 104 of the workpiece 100 which undersurface is on the underside of the top surface 101 is oriented upward as an exposed surface, and the holding surface 11 holds the mounted workpiece 100 under suction from the top surface 101 side via the adhesive tape 105. The holding surface 11 and the upper surface of the frame body of the chuck table 10 are arranged on the same plane and are formed in parallel with an XY plane as a horizontal plane. The chuck table 10 is provided so as to be movable in an X-axis direction as one direction in a horizontal direction by an X-axis moving unit not illustrated, so as to be movable in a Y-axis direction, which is another direction in the horizontal direction and orthogonal to the X-axis direction, by a Y-axis moving unit not illustrated, and so as to be rotatable about a Z-axis, which is a vertical direction and orthogonal to the XY plane, by a rotational driving source not illustrated.

As illustrated in FIG. 1, the laser processing unit 20 includes a base 21, a laser beam generating unit 30, an imaging unit 40, and a coaxial conversion irradiating unit 50. As illustrated in FIG. 1, the laser beam generating unit 30 includes a laser oscillator 31, a condensing point adjusting unit 32, and a reflecting mirror 33. The laser oscillator 31, the condensing point adjusting unit 32, and the reflecting mirror 33 are each fixed to the base 21, and mutual positional relation thereof is maintained. The laser beam generating unit 30 generates a laser beam 37, adjusts the optical characteristic of the laser beam 37, and guides the laser beam 37 to the coaxial conversion irradiating unit 50.

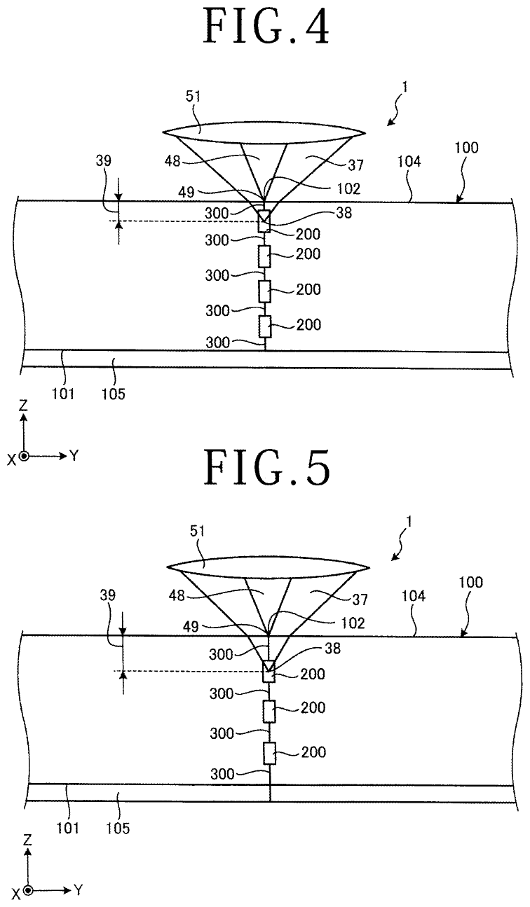

The laser oscillator 31 oscillates a laser of a wavelength transmissible through the workpiece 100 and emits the laser beam 37. The laser oscillator 31 in the present embodiment emits the laser beam 37 in a pulsed state. However, the, present invention is not limited to this. The condensing point adjusting unit 32 is disposed between the laser oscillator 31 and a dichroic mirror 51 of the coaxial conversion irradiating unit 50. The condensing point adjusting unit 32 shifts a height 39 (see FIG. 4 and FIG. 5) in a Z-axis direction (thickness direction of the workpiece 100) of a condensing point 38 (see FIG. 4 and FIG. 5) of the laser beam 37 emitted from the laser oscillator 31 without changing the height of a condensing lens 52 of the coaxial conversion irradiating unit 50. Incidentally, the height 39 of the condensing point 38 of the laser beam 37 in the present embodiment is represented by a relative height with respect to the height of the undersurface 104 of the workpiece 100 held on the chuck table 10.

The condensing point adjusting unit 32 in the present embodiment is what is generally called a liquid crystal on silicon-spatial light modulator (LCOS-SLM) that adjusts the optical characteristic of the laser beam 37 emitted from the laser oscillator 31, and emits the laser beam 37 adjusted in the optical characteristic. The optical characteristic of the laser beam 37 adjusted by the LCOS-SLM is, for example, at least one of the phase, plane of polarization, amplitude, intensity, and propagation direction of the laser beam 37. The condensing point adjusting unit 32 in the present invention is not limited to the LCOS-SLM, but may be a beam expander that increases the outside diameter of a spot of the laser beam 37 while maintaining the laser beam 37 as collimated light.

The reflecting mirror 33 is disposed between the laser oscillator 31 and the condensing point adjusting unit 32. The reflecting mirror 33 reflects the laser beam 37 emitted from the laser oscillator 31 and guides the laser beam 37 to the condensing point adjusting unit 32. In the present embodiment, one reflecting mirror 33 is provided. However, the present invention is not limited to this. The reflecting mirror 33 may not be provided, or two or more reflecting mirrors 33 may be provided.

As illustrated in FIG. 1, the imaging unit 40 includes a camera 41, a light source 42, a focus adjusting unit 43, a dichroic mirror 44, and an optical system 45. The camera 41, the light source 42, the dichroic mirror 44, and the optical system 45 are each fixed to the base 21, and mutual positional relation thereof is maintained together with each constituent of the laser beam generating unit 30. The focus adjusting unit 43 is attached to the base 21. The imaging unit 40 guides illuminating light 47 for illuminating an imaging region for the camera 41 to the coaxial conversion irradiating unit 50, guides incident light 48 from the imaging region to the camera 41 via the coaxial conversion irradiating unit 50, and images the imaging region by the camera 41 on the basis of the incident light 48 from the imaging region.

The camera 41 includes an imaging element that images the undersurface 104 of the workpiece 100 before and after laser processing or during the laser processing which workpiece is positioned in the imaging region, the planned dividing lines 102, and cracks 300 (see FIG. 4 and FIG. 5) appearing on the undersurface 104 of the workpiece 100 after the laser processing on the basis of the incident light 48 from the imaging region. The imaging element is, for example, a charge-coupled device (CCD) imaging element or a complementary metal-oxide semiconductor (CMOS) imaging element. The camera 41 obtains an image for checking for the cracks 300 appearing on the undersurface 104 of the workpiece 100 by imaging the undersurface 104 of the workpiece 100 and the like during the laser processing or after the laser processing which workpiece is held on the chuck table 10, and outputs the obtained image to the control unit 60. In addition, the camera 41 may obtain an image for detecting a region to be processed by imaging the workpiece 100 held on the chuck table 10, and outputs the obtained image to the control unit 60. The camera 41 in the present embodiment is a visible light camera. However, the present invention is not limited to this. The camera 41 may be an infrared (IR) camera or the like. The camera 41 is preferably a visible light camera. In this case, modified layers 200 (see FIG. 4 and FIG. 5) and the cracks 300 formed within the workpiece 100 are imaged so as to be superimposed on each other. There is thus an effect in that it is not difficult to identify both the modified layers 200 and the cracks 300.

Incidentally, in addition to the camera 41, the laser processing apparatus 1 may be separately provided with a camera that obtains an image for carrying out alignment that detects a region to be processed by imaging the workpiece 100 held on the chuck table 10, and outputs the obtained image to the control unit 60. The camera provided separately may be a visible light camera or an IR camera.

The light source 42 emits the illuminating light 47 for illuminating the imaging region for the camera 41. The light source 42 is, for example, a xenon flash lamp that emits white light, a white LED, or the like.

The focus adjusting unit 43 adjusts the height of a focus 49 (see FIG. 4 and FIG. 5) of the camera 41 and the height 39 of the condensing point 38 of the laser beam 37 by moving the base 21 in a height direction perpendicular to the holding surface 11 of the chuck table 10 (the Z-axis direction or the thickness direction of the workpiece 100). Incidentally, in the present embodiment, as with the height 39 of the condensing point 38 of the laser beam 37, the height of the focus 49 of the camera 41 is represented by a relative height with respect to the height of the undersurface 104 of the workpiece 100 held on the chuck table 10. The focus adjusting unit 43 integrally moves all constituents fixed to the base 21, that is, each constituent of the laser beam generating unit 30, the camera 41, the light source 42, the dichroic mirror 44, and the optical system 45 of the imaging unit 40, and each constituent of the coaxial conversion irradiating unit 50 (the dichroic mirror 51 and the condensing lens 52) without changing mutual positional relation thereof. Therefore, the focus adjusting unit 43 can move the focus 49 of the camera 41 and the condensing point 38 of the laser beam 37 in the height direction without changing the focal length of the camera 41 and without changing a state in which the laser beam 37, the incident light 48 to be made incident on the camera 41, and the illuminating light 47 are coaxially superimposed on each other.

The dichroic mirror 44 is disposed between the camera 41 and the dichroic mirror 51 and between the light source 42 and the dichroic mirror 51, that is, at a point of intersection of the incident light 48 and the illuminating light 47. The dichroic mirror 44 reflects the illuminating light 47 from the light source 42 and guides the illuminating light 47 to the condensing lens 52, and transmits the incident light 48 from the condensing lens 52 and guides the incident light 48 to the camera 41.

The optical system 45 is disposed between the camera 41 and the dichroic mirror 44. The optical system 45 condenses the incident light 48 from the condensing lens 52 which incident light is transmitted through the dichroic mirror 44, and guides the incident light 48 to the camera 41. In the present embodiment, one optical system 45 is provided. However, the present invention is not limited to this. Two or more optical systems 45 may be provided.

The coaxial conversion irradiating unit 50 includes the dichroic mirror 51 and the condensing lens 52. The dichroic mirror 51 and the condensing lens 52 are each fixed to the base 21, and mutual positional relation thereof is maintained together with each constituent of the laser beam generating unit 30 and the camera 41, the light source 42, the dichroic mirror 44, and the optical system 45 of the imaging unit 40.

The dichroic mirror 51 is disposed between the condensing point adjusting unit 32 and the condensing lens 52 and between the dichroic mirror 44 and the condensing lens 52, that is, at a point of intersection of the laser beam 37 and the illuminating light 47 and the incident light 48. The dichroic mirror 51 reflects the laser beam 37 from the condensing point adjusting unit 32 and guides the laser beam 37 to the condensing lens 52, transmits the illuminating light 47 transmitted through the dichroic mirror 44 and guides the illuminating light 47 to the condensing lens 52, and transmits the incident light 48 from the condensing lens 52 and guides the incident light 48 to the dichroic mirror 44. The dichroic mirror 51 thereby coaxially superimposes the laser beam 37, the illuminating light 47, and the incident light 48 on each other on the condensing lens 52 side. By thus coaxially superimposing the laser beam 37, the illuminating light 47, and the incident light 48 on each other, the dichroic mirror 51 positions a processing region of the workpiece 100 which region is to be processed by the laser beam 37, an illumination region for the illuminating light 47, and the imaging region for the camera 41 so as to be superimposed on each other.

The condensing lens 52 is disposed more to the imaging region side of the camera 41 than the dichroic mirror 51, that is, more to the holding surface 11 side of the chuck table 10 than the dichroic mirror 51. The condensing lens 52 is irradiated with the laser beam 37 from the dichroic mirror 44, forms the condensing point 38 of the laser beam 37, and irradiates the processing region of the workpiece 100 held on the chuck table 10 with the laser beam 37. The condensing lens 52 thereby subjects the processing region of the workpiece 100 to laser processing to form a modified layer 200. The condensing lens 52 is irradiated with the illuminating light 47 from the dichroic mirror 44, and irradiates the illumination region of the workpiece 100 held on the chuck table 10 with the illuminating light 47. The condensing lens 52 thereby illuminates the imaging region for the camera 41. The condensing lens 52 forms the focus 49 of the camera 41, and guides, to the dichroic mirror 51, the incident light 48 reflected from the imaging region for the camera 41 which imaging region is illuminated by the illuminating light 47.

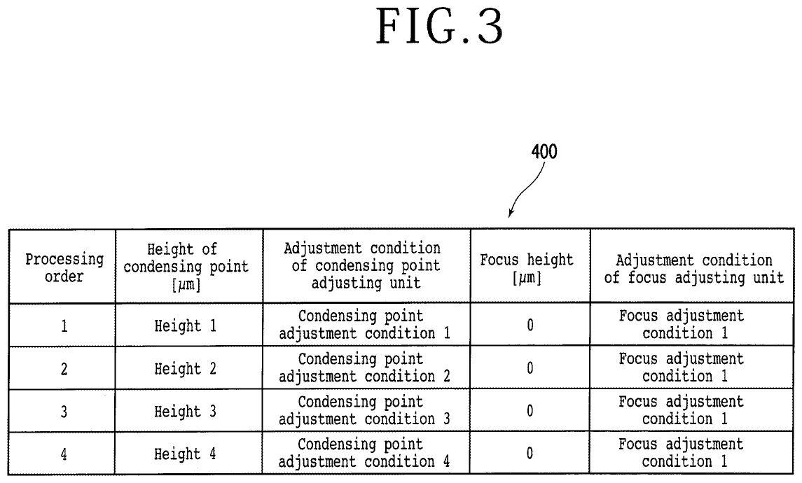

The control unit 60 makes the laser processing apparatus 1 to perform laser processing on the workpiece 100 by controlling the operation of each constituent of the laser processing apparatus 1. The control unit 60 includes a registering section 61. The control unit 60 makes the registering section 61 register registration data 400 (see FIG. 3) including the height 39 of the condensing point 38 and the height of the focus 49 of the camera 41. The control unit 60 refers to the registration data 400 registered in the registering section 61, and on the basis of the registration data 400, the control unit 60 controls the laser oscillator 31, the condensing point adjusting unit 32, and the focus adjusting unit 43 to thereby control the optical characteristic of the laser beam 37 and the height 39 in the Z-axis direction of the condensing point 38 of the laser beam 37, and controls the focus adjusting unit 43 to thereby control the height 39 of the condensing point 38 of the laser beam 37 and the height of the focus 49 of the camera 41. In addition, the control unit 60 controls the light source 42 to thereby control the illuminance of the illuminating light 47 or the like.

FIG. 3 is a diagram illustrating an example of registration data registered by the registering section 61 of the laser processing apparatus 1 in FIG. 1 (registration data 400). As illustrated in FIG. 3, for each processing order of irradiation with the laser beam 37 and imaging in the camera 41, the registering section 61 stores the height 39 of the condensing point 38 of the laser beam 37, an adjustment condition of the condensing point adjusting unit 32 for realizing the height 39 of the condensing point 38 of the laser beam 37, the height of the focus 49 of the camera 41, and an adjustment condition of the focus adjusting unit 43 for realizing the height of the focus 49 of the camera 41 in the registration data 400 in association with each other.

In addition, the control unit 60 controls relative positional relation between the chuck table 10 and the laser processing unit 20 by controlling the X-axis moving unit and the Y-axis moving unit not illustrated on the basis of an image for performing alignment, for example, the image being imaged by the camera 41. The control unit 60 thereby controls the positions of the processing region of the workpiece 100 to be processed by the laser beam 37, the illumination region for the illuminating light 47, and the imaging region for the camera 41 on the top surface 101 of the workpiece 100 held on the chuck table 10.

In addition, the control unit 60 detects the cracks 300 extending to the undersurface 104 of the workpiece 100 on the basis of an image for checking for the cracks 300, the image being imaged by the camera 41. In the image for checking for the cracks 300, the undersurface 104 of the workpiece 100 excellently reflects the illuminating light 47, so that the light amount of the incident light 48 on the camera 41 is increased and the undersurface 104 of the workpiece 100 is imaged with high luminance. On the other hand, in the image for checking for the cracks 300, the cracks 300 extending to the undersurface 104 of the workpiece 100 reflect a small amount of the illuminating light 47 as compared with the undersurface 104 of the workpiece 100, so that the light amount of the incident light 48 on the camera 41 is reduced and the cracks 300 are imaged with low luminance. The control unit 60 thereby identifies the cracks 300 in the image for checking for the cracks 300.

The control unit 60 in the present embodiment includes a computer system. The computer system included in the control unit 60 includes an arithmetic processing device having a microprocessor such as a central processing unit (CPU), a storage device having a memory such as a read only memory (ROM) or a random access memory (RAM), and an input-output interface device. Functions of the control unit 60 in the present embodiment are implemented by the arithmetic processing device of the computer system included in the control unit 60 by executing a computer program stored in the storage device of the computer system included in the control unit 60. The arithmetic processing device of the control unit 60 performs arithmetic processing according to the computer program stored in the storage device of the control unit 60, and outputs a control signal for controlling the laser processing apparatus 1 to each constituent of the laser processing apparatus 1 via the input-output interface device of the control unit 60. Functions of the registering section 61 in the present embodiment are implemented by the storage device of the computer system included in the control unit 60.

Operation and processing of the laser processing apparatus 1 according to the embodiment will next be described with reference to the drawings. FIG. 4 is a sectional view illustrating an example of the operation of the laser processing apparatus 1 in FIG. 1. FIG. 4 illustrates the operation of the laser processing apparatus 1 in a case where the control unit 60 performs control processing on the laser processing apparatus 1 on the basis of the registration data 400 illustrated in FIG. 3.

As illustrated in FIG. 4, the laser processing apparatus 1 according to the embodiment sets the height 39 of the condensing point 38 of the laser beam 37 in regions at a plurality of different depths from the undersurface 104 within the workpiece 100, and applies the laser beam 37. The laser processing apparatus 1 according to the embodiment thereby performs processing of forming modified layers 200 in the regions at the plurality of different depths. When the modified layers 200 are formed within the workpiece 100, cracks 300 extend from the modified layers 200 within the workpiece 100 along the height direction (the Z-axis direction or the thickness direction of the workpiece 100).

In a case where such operation of the laser processing apparatus 1 is to be performed, the control unit 60 first selects registration data 400 to be referred to when performing control processing on the laser processing apparatus 1 on the basis of various processing conditions such as the thickness of the workpiece 100 and the number of layers at the depths at which to form the modified layers 200 by applying the laser beam 37 and thereby performing laser processing.

The control unit 60 next forms the modified layers 200 in respective layers within the workpiece 100 on the basis of the selected registration data 400. The control unit 60 in the present embodiment sequentially forms the modified layers 200 from a layer on a lower side. Specifically, in the example illustrated in FIG. 4, the control unit 60 first forms a modified layer 200 in a deepest fourth layer as viewed from the undersurface 104 side of the workpiece 100, and next forms modified layers 200 in order of a third layer as a layer immediately above the fourth layer, a second layer as a layer further above, and a first layer closest to the undersurface 104 of the workpiece 100. Then, a crack 300 extends from the modified layer 200 formed in the first layer to the undersurface 104 of the workpiece 100. Incidentally, the control unit 60 in the present invention is not limited to this. The control unit 60 may form the modified layers 200 in the respective layers in freely-selected order.

On the basis of the selected registration data 400, the control unit 60 simultaneously adjusts the height 39 of the condensing point 38 of the laser beam 37 and the height of the focus 49 of the camera 41 by adjusting the focus adjusting unit 43, and thereafter adjusts the height 39 of the condensing point 38 of the laser beam 37 by adjusting the condensing point adjusting unit 32. When the control unit 60 is to form the modified layer 200 in the fourth layer first, for example, the control unit 60 sets the height 39 of the condensing point 38 of the laser beam 37 and the height of the focus 49 of the camera 41 at the undersurface 104 of the workpiece 100 (focus height in FIG. 3 is “0”) by setting the condition of the focus adjusting unit 43 to a “focus adjustment condition 1” in FIG. 3, and thereafter sets the height 39 of the condensing point 38 of the laser beam 37 at the depth of the fourth layer (“height 1” in FIG. 3) by setting the condition of the condensing point adjusting unit 32 to a “condensing point adjustment condition 1” in FIG. 3. A difference in height between the condensing point 38 of the laser beam 37 and the focus 49 of the camera 41 is, for example, approximately 10 to 120 μm.

In addition, when the control unit 60 is to form the modified layers 200 in the third layer, the second layer, and the first layer, respectively, because the control unit 60 already set the height of the focus 49 of the camera 41 to the undersurface 104 of the workpiece 100 when forming the modified layer 200 in the fourth layer, the control unit 60 does not need to set the condition of the focus adjusting unit 43 again. The control unit 60 sets the height 39 of the condensing point 38 of the laser beam 37 at the depths of the third layer, the second layer, and the first layer, respectively (a “height 2,” a “height 3,” and a “height 4” in FIG. 3) by setting the condition of the condensing point adjusting unit 32 to a “condensing point adjustment condition 2,” a “condensing point adjustment condition 3,” and a “condensing point adjustment condition 4,” respectively, in FIG. 3.

Incidentally, in the present embodiment, when the control unit 60 is to form the modified layers 200 in the fourth layer, the third layer, and the second layer, the control unit 60 does not performs observation by the camera 41 at the same time as irradiation with the laser beam 37, and therefore the control unit 60 may set both the height 39 of the condensing point 38 of the laser beam 37 and the height of the focus 49 of the camera 41 at the heights of the layers to be processed in the workpiece 100 by controlling the focus adjusting unit 43.

When the control unit 60 is to form the modified layers 200 in the fourth layer, the third layer, and the second layer, the control unit 60 sets the height 39 of the condensing point 38 of the laser beam 37 and the height of the focus 49 of the camera 41, and thereafter sets the positions of the processing region of the workpiece 100 which region is to be processed by the laser beam 37, the illumination region for the illuminating light 47, and the imaging region for the camera 41 on a planned dividing line 102 formed on the top surface 101 of the workpiece 100 held on the chuck table 10. The control unit 60 moves the laser processing unit 20 and the chuck table 10 holding the workpiece 100 relative to each other along the planned dividing line 102 while applying the laser beam 37 by controlling the laser processing unit 20. The control unit 60 thereby forms the modified layers 200 along the planned dividing line 102 in the regions at the depths of the fourth layer, the third layer, and the second layer, respectively, within the workpiece 100 in which the height 39 of the condensing point 38 of the laser beam 37 is set.

When the control unit 60 is to form the modified layer 200 in the first layer, the control unit 60 forms the modified layer 200 in the region at the depth of the first layer along the planned dividing line 102 by applying the laser beam 37 after various kinds of settings as in forming the modified layers 200 in the fourth layer, the third layer, and the second layer. Meanwhile, the control unit 60 further images the undersurface 104 of the workpiece 100 along the planned dividing line 102 by the camera 41 having the focus 49 set at the undersurface 104 as an exposed surface of the workpiece 100.

When the crack 300 extending from the modified layer 200 formed within the workpiece 100 extends to the undersurface 104, the control unit 60 can image the crack 300 extending to the undersurface 104 by imaging the undersurface 104 of the workpiece 100 by the camera 41. On the basis of an image imaged by the camera 41, the control unit 60 detects whether or not the crack 300 extending from the modified layer 200 within the workpiece 100 has extended to the undersurface 104.

FIG. 5 is a sectional view illustrating another example of the operation of the laser processing apparatus 1 in FIG. 1. The example illustrated in FIG. 5 is an example in which the depths at which to form the modified layers 200 by applying the laser beam 37 and the number of layers at the depths in the example illustrated in FIG. 4 are changed. It is to be noted that while the number of layers at the depths at which to form the modified layers 200 by applying the laser beam 37 in the laser processing apparatus 1 in the examples illustrated in FIG. 4 and FIG. 5 are 4 and 3, respectively, the present invention is not limited to this, but the number of layers at the depths at which to form the modified layers 200 by applying the laser beam 37 may be two or less or may be five or more.

The laser processing apparatus 1 according to the embodiment having a configuration as described above can image the processing region of the workpiece 100 during laser processing or immediately after the laser processing by coaxially irradiating one condensing lens 52 with the laser beam 37 for the laser processing and the illuminating light 47 for imaging. In addition, the laser processing apparatus 1 according to the embodiment can set the height 39 of the condensing point 38 of the laser beam 37 and the height of the focus 49 of the camera 41 that performs imaging at respective different heights by the condensing point adjusting unit 32 and the focus adjusting unit 43. Therefore, the laser processing apparatus 1 according to the embodiment can immediately image the crack 300 extending from the modified layer 200 to the undersurface 104 when forming the modified layer 200 in the vicinity of the exposed surface (undersurface 104) of the workpiece 100 substantially in parallel with the laser processing from the side on which the laser processing is performed by applying the laser beam 37. Actions and effects are thus produced in that whether or not the crack 300 has occurred from the modified layer 200 and has extended to the undersurface 104 can be checked efficiently.

In addition, in the laser processing apparatus 1 according to the embodiment, the condensing point adjusting unit 32 is a spatial light phase modulator or a beam expander. Therefore, the laser processing apparatus 1 according to the embodiment can shift the height 39 of the condensing point 38 of the laser beam 37 by the condensing point adjusting unit 32 with high accuracy without moving one condensing lens 52. That is, the laser processing apparatus 1 according to the embodiment can shift the height 39 of the condensing point 38 of the laser beam 37 with high accuracy without shifting the height of the focus 49 of the camera 41. Thus, the height 39 of the condensing point 38 of the laser beam 37 and the height of the focus 49 of the camera 41 that performs imaging can be set at respective different desired heights with high accuracy.

The present invention is not limited to the details of the above described preferred embodiment. The scope of the invention is defined by the appended claims and all changes and modifications as fall within the equivalence of the scope of the claims are therefore to be embraced by the invention.

What is claimed is:

1. A laser processing apparatus for irradiating a workpiece with a laser beam along a planned dividing line set on the workpiece, the laser processing apparatus comprising:
a chuck table configured to hold the workpiece by a holding surface;
a laser oscillator configured to emit the laser beam of a wavelength transmissible through the workpiece;
a camera configured to image the workpiece;
a light source configured to illuminate an imaging region for the camera;
a condensing lens configured to form a condensing point of the applied laser beam and form a focus of the camera;
a focus adjusting unit configured to adjust a height of the focus of the camera by moving a base to which the camera and the condensing lens are fixed in a height direction perpendicular to the holding surface;
a condensing point adjusting unit disposed between the laser oscillator and the condensing lens, and configured to shift a height of the condensing point of the laser beam without changing a height of the condensing lens; and
a control unit including a registering section configured to register the heights of the condensing point and the focus, the control unit being configured to control the focus adjusting unit and the condensing point adjusting unit on a basis of information of the registering section, wherein,
while the condensing point is set within the workpiece, and a modified layer is formed within the workpiece along the planned dividing line, a crack extending from the modified layer to an exposed surface of the workpiece is photographed by the camera having the focus set at the exposed surface.

2. The laser processing apparatus according to claim 1, wherein
the condensing point adjusting unit is selected from a group including a spatial light phase modulator and a beam expander.
